(19) United States
(12) Patent Application Publication
(10) Pub. No.: US 2019/0105234 A1
(43) Pub. Date: Apr. 11, 2019

(54) Method and Apparatus for a Pill Container with Removable Tabs

(71) Applicants: Miteshkumar Ishwarbhai Patel, San Leandro, CA (US); Raj Kalpesh Patel, San Jose, CA (US)

(72) Inventors: Miteshkumar Ishwarbhai Patel, San Leandro, CA (US); Raj Kalpesh Patel, San Jose, CA (US)

(73) Assignee: Meditab Software, Inc., Sacramento, CA (US)

(21) Appl. No.: 15/729,637

(22) Filed: Oct. 10, 2017

(51) Int. Cl. A61J 7/04; A61J 1/03; B65D 50/04

(52) U.S. Cl. CPC A61J 7/04; B65D 50/046; A61J 1/03

(57) ABSTRACT

A method and apparatus for removing or breaking tabs from a pill container is described. The system for performing the method is based in a computerized and networked environment and utilizes a tab removal machine for breaking the tabs of the pill container.

The pill container is part of a pill container assembly that includes a pill container housing and a cap that can rotatably fit and lock with the housing of the pill container. The housing is a hollow cylinder having a wider opening at the top and a narrower enclosed bottom and a cylindrical and tapered body in-between. The housing includes a flange that has a section for breakable tabs. Each of the breakable tabs is labeled with an hour of administration (HOA) that identifies the HOA for the medications that are to be stored within the pill container. The breakable tabs include perforations around them to allow a force to be applied such that they break along the lines of the perforation.

The tab removal machine includes a base plate, a cover, a tab breaking mechanism having a plurality of pistons, a circular protrusion at its base for inserting a pill container, and a alignment protrusion for inserting inside a hole of the pill container. The tab breaking mechanism is capable of moving up and down and engaging with the pill container housed in the circular protrusion. The pistons are capable of moving up and down to independent apply a force on a desired tab of the pill container for breaking it away from the flange. In one instance, the base of the tab removal machine is a conveyor belt with a plurality of circular protrusions for housing a plurality of pill containers at a time.

The method for removing a tab from the pill container includes receiving a pill container in the circular protrusion of the base plate. The pill container is then locked within the circular protrusion by having the circular protrusion wrap along the bottom of the pill container as well as inserting an alignment protrusion inside the hole of the pill container to restrict it in the XY plane. The system then determines the hours of administration (HOA) for the pills that are to be stored in the pill container by querying a database to obtain the HOA. Based upon the data received, the tab removal machine removes the tabs with HOAs that are not associated with medication to be stored in the pill container, i.e. HOA that are not in the regimen for the specific patient for whom the pill container is intended. The breaking of the tab occurs by applying pressure to the tab using a movable protruding arm of the tab breaking mechanism, thereby resulting in the tab being broken away from the flange along the lines of perforations.

### BACKGROUND OF THE INVENTION

### Field of the Invention

This application is related to pill container having removable tabs, and more particularly, to a method for selectively removing tabs from the pill container by using a tab removal machine.

### Discussion of the Related Art

Patients are usually prescribed a certain dosage of medication by their doctors. The dosages are typically for a certain number of days depending upon the specific need and regimen required to cure their illness or to sustain their ongoing treatment, for example, a doctor may prescribe a medication to be taken for 7, 14 or even 30 days. These large numbers of pills, medications, and or vitamins may be in the form of pills, caplets, capsules, and or tablets. The pills are bottled by Pharmacy or a Medical Pill Dispensing Units in a vial. The vial is simply a container for holding pills.

The regimens may require the patient to take the pills in the vial, on a specific day or a specific time. For example, regimens may require the pills to be take once a week or twice a week or to be taken daily in the morning. To remember these days and times, various reminders are provided by the pharmacies as well as the vial manufacturers. These reminders include labels on the vial bottle or even a dial reminder that includes a very small print of the days and times for the pill to be taken.

One method used in the past to provide a reminder is described in U.S. Pat. No. 820,169B1 (The '169 Patent), Pill intake reminder and container cap device and method of use thereof. The '169 Patent provides a dial that is part of the cap and the dial is labeled with days of the week as a reminder to the patient. The cap contains compressions that are labeled with the days of the week. There are several problems with this approach. First, the labeled dial with the reminder is part of the cap. Since caps can be detached from the main body of the pill container, it's easy to lose the cap or accidentally place a cap from one vial onto another vial that could result in the patient to take the wrong medication. Second, the labeling is in small print and hard to read by the patient. Third, the compressions are not easily identifiable and cannot be quickly assessed to determine whether the pills are meant for a Tuesday or a Wednesday when the Wednesday label may be compressed causing the patient to take a more closer look. Yet another disadvantage is that patients of old age, severe illness causing them to have limited judgment, or blind or partially blind patient, may not be able to independently identify the vial without having additional help. Further, this the invention of the '169 patent also does not all such patients to just touch the vial by their fingers and determine the contents as well as the times of the day for the pill to be takes and requires them to pay close attention to detail, ask for help from others, or use glasses to read and select the right vial—which in many instances is not possible for them.

Other approaches to provide reminders use digital readout, are clunky, difficult to manufacture or costly. Also, due to the form factor of the vials, which are typically small, the labeling used is also small and hard to read thereby causing additional hardship to the patients. Additionally, prior art reminders that have attachments to the cap also suffer from the disadvantage of being broken off or the labeling being stripped off and cause confusion as determine the regimen for the pills in that vial. As such, there is a need for a vial that is easily discernable and eliminates confusion for easy identification of the regimen of the pills inside the vial.

### SUMMARY OF THE INVENTION

According to the disclosed embodiments, a pill container having removable tabs and a method for selectively removing the removable tabs from the pill container by using a tab removal machine is disclosed.

The system is based in a computerized and networked environment and utilizes a tab removal machine for breaking the tabs of the pill container. The networked environment also includes a server computer, client computers, and an associated database.

The pill container is part of a pill container assembly that includes a pill container housing and a cap. The cap can be fitted on the pill container by rotating it about the threads of the pill container housing to fit and lock with the housing of the pill container.

The housing is a hollow cylinder having a wider opening at the top and a narrower enclosed bottom and a cylindrical and tapered body in-between. The housing includes a flange that has a section for breakable tabs. Each of the breakable tabs is labeled with an hour of administration (HOA) that identifies the HOA for the medications that are to be stored within the pill container. The breakable tabs include perforations around them to allow a force to be applied such that they break along the lines of the perforation.

The housing also includes a locking feature that is a push and release tab that protrudes outwards from the flange. To detach the cap from the pill container housing, the user may push down on the push release tab and untwist the cap at the same time.

The tab removal machine includes a base plate, a cover, a tab breaking mechanism having a plurality of pistons, a circular protrusion at its base for inserting a pill container, and a alignment protrusion for inserting inside a hole of the pill container. The tab breaking mechanism is capable of moving up and down and engaging with the pill container housed in the circular protrusion. The pistons are capable of moving up and down to independent apply a force on a desired tab of the pill container for breaking it away from the flange. In one instance, the base of the tab removal machine is a conveyor belt with a plurality of circular protrusions for housing a plurality of pill containers at a time.

The method for removing a tab from the pill container includes receiving a pill container in the circular protrusion of the base plate. Locking the pill container within the circular protrusion by having the circular protrusion wrap along the bottom of the pill container as well as inserting an alignment protrusion inside the hole of the pill container to restrict it in the XY plane. The system then determines the hours of administration (HOA) for the pills that are to be stored in the pill container by querying a database to obtain the HOA. The HOA is specific for each patient and the medications that are to be taken by that specific patient that are stored in the pill container that is being processed. Based upon the data received, the tab removal machine removes the tabs with HOAs that are not associated with medication to be stored in the pill container, i.e. HOA that are not in the regimen for the specific patient for whom the pill container is intended. The breaking of the tab occurs by applying pressure to the tab using a movable protruding arm of the tab breaking mechanism, thereby resulting in the tab being broken away from the flange along the lines of perforations.

### BRIEF DESCRIPTION OF THE DRAWINGS

The accompanying drawings are included to provide further understanding of the invention and constitute a part of the specification. The drawings listed below illustrate embodiments of the invention and, together with the description, serve to explain the principles of the invention, as disclosed by the claims and their equivalents.

FIG. 1 depicts a system for selectively removing tabs from a pill container having removable tabs, according to the disclosed embodiments.

FIG. 2 is perspective view of a pill container with removable tabs and a cap, according to the disclosed embodiments.

FIG. 3 is a perspective view depicting the pill container along with detailed views of its engagement sections, according to some of the disclosed embodiments.

FIG. 4 is a front view of the pill container, according to some of the disclosed embodiments.

FIG. 5 is a top view of the housing of the pill container, according to some of the disclosed embodiments.

FIG. 6 is a bottom view of the housing of the pill container with detents, according to some of the disclosed embodiments.

FIG. 7 is a bottom view of the housing of the pill container with a detent, according to some of the disclosed embodiments.

FIG. 8 is a perspective view of the pill container assembly with desired tabs removed from the flange, according to some of the disclosed embodiments.

FIG. 9 is a front view of a plurality of pill containers stacked within each other, according to some of the disclosed embodiments.

FIG. 10 is a perspective view of the tab removal machine, according to some of the disclosed embodiments.

FIG. 11 is a perspective view of the tab removal machine with a conveyor belt, according to some of the disclosed embodiments.

FIG. 12 is a flowchart illustrating one method of operation of selectively removing a tab from the pill container with removable tabs, according to the disclosed embodiments.

While the embodiments of the application are susceptible to various modifications and alternative forms, specific embodiments are provided as examples in the drawings and detailed description. It should be understood that the drawings and detailed description are not intended to limit the embodiments to the particular form disclosed. Instead, the intention is to cover all modifications, equivalents and alternatives falling within the spirit and scope of the invention as defined by the appended claims.

### DETAILED DESCRIPTION

Aspects of the invention are disclosed in the accompanying description. Alternate embodiments of the present invention and their equivalents are devised without parting from the spirit or scope of the present invention. It should be noted that like elements disclosed below are indicated by like reference numbers in the drawings. While the embodiments discussed below describe a pill container with removable tabs, a tab removable machine for removing the removable tabs, and a method for removing the removable tabs, these approaches are not so limited and equally applicable to other variations.

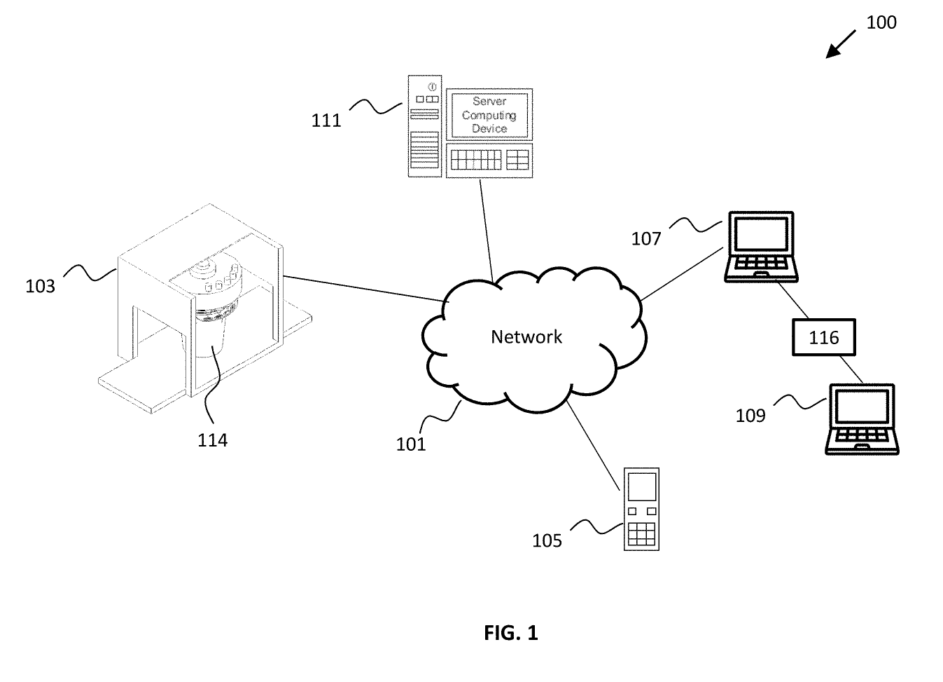

FIG. 1 depicts a system for selectively removing tabs from a pill container having removable tabs. System 100 includes a network, a tab removing machine, client computers, a handheld device, and a server computing device.

The network may be local area networks (LAN), wide area network (WAN), or a wireless network. It may be configured to connect directly or remotely to other networks as well as to a tab removing machine 103, a handheld device 105, client computing devices 107 and 109, and/or a server computing device 111.

Client computing devices 107 and 109 may include any device capable of receiving and sending data over the network 101. Handled devices 105 may include portable devices such as cellular telephones, smart phones, radio frequency-enabled devices, personal digital assistants, handheld computers, tablets, wearable computers and the like. Handheld device 105 may include any computing device that connects to a network using a wired communications medium such as personal computers, processors, multiprocessor systems, microprocessor-based or programmable consumer electronics, network personal computers and the like.

Client computing devices 107 and 109 may be web-enabled client devices that include a browser application configured to receive and to send web pages, web-based messages and the like. Client computing devices 107 and 109 also may include at least one other client application that is configured to receive content from another computing device, including, without limit, a server computing device 111. The client application may include a capability to provide and receive textual content, multimedia information, or the like.

Client devices 107 and 109 may further be configured to include a client application that enables the user to log into a user account that may be managed by another computing device. Such as a user account, for example, may be configured to enable the user to receive emails, send/receive IM messages, SMS messages, access selected web pages, download scripts, applications, or a variety of other content, or perform a variety of other actions over a network.

Network 111 may be configured to communicate with server computing device 111 or additional servers in or outside the network.

The tab removing machine 103 communicates with all the components in the system 100 either directly, through the network 101, or through network and any one of its components, such as through the server computing device. The tab removing machine 103 includes a space for placing a pill container having removable tabs 114. The pill container having removable tabs 114 is used for housing medications, such as tablets, capsules, or any other solid medication. Alternatively, the pill container may also be configured to house liquid medication.

In one embodiment, the tab removing machine 103 communicates with the client computing devices 107 and 109 (either directly, through network 101, or through server computing device 111). The communications between the tab removing machine 103 and the client computing devices allow the client computing devices 107 and 109 to direct operations of the tab removing machine 103,

For example, the client computing devices 107 and 109 may direct operations of the tab removing machine 103, provide data to the tab removing machine 103 for it to make certain decisions, or verifications, such as a verification that the pill container 114 placed within the tab removing machine 103 is the associated with a specific patient, or corresponds to a specific prescription for a specific patient, and approved for further processing.

Computing device 109 is configured to generate and/or modify a prescription plan, along with its schedule of taking medications, and provide them to tab removing machine 103. In one embodiment, computing device 109 can execute (e.g., by using the one or more processors) a plan generation module 116 to access, generate, and/or modify a plan 116. Plan 116 indicates a pill distribution schedule and the type of medications to be taken by a specific patient. Plan 116 is then communicated to tab removing machine 103, which can be executed by computing device 107 (e.g., by using one or more processors). Using these plans are then used by the tab removing machine 103 to make certain determinations and then to remove certain tabs from the pill container 114 that are not in the plan. For example, after obtaining a prescription plan that includes a pill taking schedule for just morning time, the computing device 107 will direct the tab removing machine 103 to remove all tabs from the pill container 114 and leave behind the tab associated with morning thereby making it convenient for a patient or caregiver to easily associate the pill container 114 for a morning pill intake regimen.

In addition to the above, the embodiments described herein, including systems, methods/processes, and/or apparatuses, may be implemented using well known servers/computers shown in FIG. 1. These servers, computers, or even the tab removal machine, which may include its own onboard computer, includes one or more processors (e.g., central processing units (CPUs)). The processor can simultaneously operate multiple computing threads. The computer also includes a primary or main memory, such as a random access memory (RAM) and control logic stored therein. The computer also includes one or more secondary storage devices. Secondary storage devices include, for example, a hard disk drive and/or a removable storage device or drive, as well as other types of storage devices, such as memory cards and memory sticks. For instance, the tab removal machine may also include hardware components that allow insertion of a removable storage device, or a USB device, to obtain the stored data therein. The stored data may be the details of each pill container processed, types and number of tabs removed etc. The system also includes control logic that may be transmitted to and from computer. For example, Control logic may be used to align the pill container with the tab breaking mechanism or to determine which tab to break. Additionally, the control logic may be used in any of the flowcharts or operations that require a decision-making step before processing a pill container or breaking a removable tab.

Various embodiments of communications between the various components of the system, selective removal or tabs, and the pill are described in further detail with reference to the Figures below.

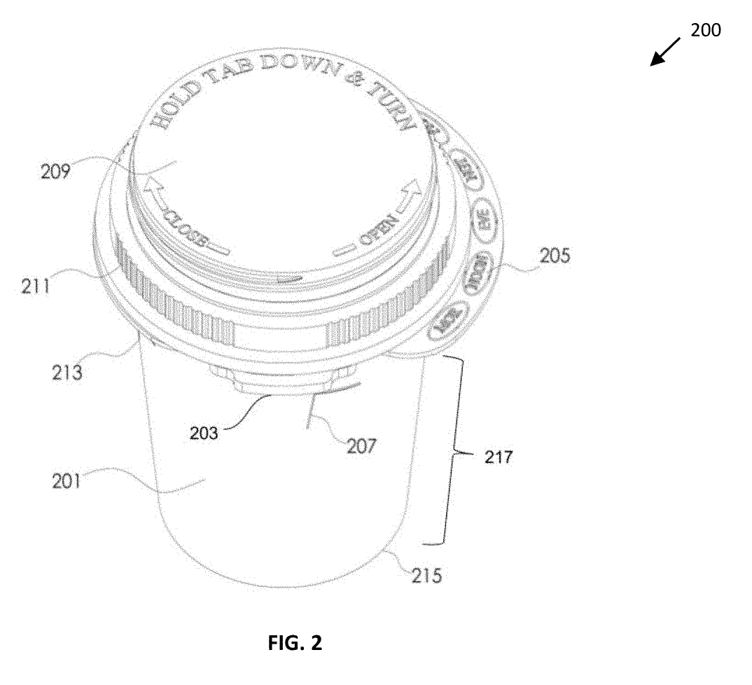

FIG. 2 is perspective view of a pill container with removable tabs and a cap, according to the disclosed embodiments. The pill container 200 includes housing 201, a locking feature 203, a section for tabs 205, a label section 207, and a cap 209, together forming a pill container assembly. The cap includes external threads 211. The cap also includes internal threads that act as a locking mechanism. These internal threads are used for matably connecting with threads from the housing 201 such that once the two threads are rotated about each other, the cap is tightened and locked in with the housing to form one housing-cap assembly. Further details of the pill container 200 and the pill container assembly are described with respect to its various embodiments as depicted through 3-9, including showing its various front, top, bottom, and cross-sectional views.

The pill container assembly is used for storing medications such as pills, tablets, capsules, vitamins, or other forms or solid medication. Alternatively, the pill container assembly may also be used for storing liquid medication when a liquid protection seal is added to the cap. The pill container is also referred to as vial, pill vial, pill bottle, pharmacy bottle, pharmacy vial, plastic dram vial, prescription vials, or prescription bottles. Yet, in another embodiment, the vial may be used certain skin application products that are used as a dermatological medicine and have the need to be applied on a certain day or time of the day.

The housing 201 of the pill container 200 includes an upper end section 213. This section has an opening, also referred to as a mouth, which is used for depositing and taking out medications. The upper end and the mouth has a wide opening and is also used for placing the cap 209 on the housing 201.

The housing 201 of the pill container 200 includes a lower or bottom end section 215. This section defines a bottom surface of the pill container 200. The bottom section is closed from below providing a floor or a base for the medication stored within the pill container 200.

The housing 201 of the pill container 200 has a surrounding wall 217. This wall extends from the upper end section 213 to the bottom end section 215 fully encapsulating the inside and defining an exterior surface and an interior surface for the housing 201 of the pill container 200.

The housing 201 of the pill container 200 is circular with the diameter of the upper end section 213 being wider than the diameter of the bottom end section 215. The wider top and the narrower bottom results in creating a tapered tubular body. The variance between the diameters of the upper mouth and the floor of the housing 201 may vary as desired. The variance would also dictate the angle of the surrounding wall 217. As will be further explained below, the angle of this tapered tubular section allows stacking of multiple pill containers within each other. The wider top and narrower bottom configuration also assists in a better grip for the user in holding the pill container in their hands.

The upper end section 213, i.e. the mouth of the housing 201, includes a flange that extends radially from the surrounding wall 217. This flange extends around a portion of the outer circumference of the upper end section 213 that is closer to the mouth/opening of the housing 201. The flange includes the locking feature 203, a section for tabs 205, and an engagement surface for engaging with the cap 209.

The flange's engagement surface can engage with the cap 209 in a similar fashion as a screw and bolt. For example, the engagement surface may be threaded to receive a cap through which a cap can be rotatably inserted and tightened with respect to the housing 201. Once the cap 209 is tightened with the housing 201 through these threads, the assembled pill container would form a seal at the mouth thereby preventing any debris from entering the pill container. Alternatively, the seal may also be leak proof in the event of any liquid medication being housed inside the pill container 200 and water and liquid proof from the outside preventing any liquid from entering the pill container 200.

The cap 209 also includes external threads 211. The external threads allow the user to grip the cap 209 such that they may exert force clockwise or anti-clockwise without their grip slipping from the cap 209. The external threads 211 also make it easy to open the bottle when the user's hands are greasy, oily, or require an additional grip.

As mentioned above, the housing 201 of the pill container 200 includes a locking feature 203. This locking feature is part of the flange. In one embodiment. The locking feature is a push and release tab that protrudes outwards from the external surface the surrounding wall. This push and release tab is located in the upper end section 213 and near the opening or mouth at the top. In operation, in order to open the cap 209 from the housing 201, the user may have to push down on the cap and untwist the cap 209 to unlock or push on the push and release tab, untwist the cap 209 while keeping the push and release tab pushed in until is surpasses a locking point and then release the push and release tab resulting in removal of the cap 209 from the housing 201. Basically, the push and release tab 203, also referred to as the locking feature, functions to release the cap 209 from the housing 201 from its locked state.

The locked state refers to the cap 209 being tightly placed on the housing 201 such that it cannot be opened by a child, also referred to as “child resistant lock”. This implies that in order to open the cap from this child safety status, a dual operation needs to be performed at the same time to unlock the structural elements and that usually require coordination, skill, strength that is atypical of what a child under a certain age possesses thereby making it child safe.

The child safety mechanism protects children from accidental poisoning by intake of the medication housed in the housing 201 so that a child may not without adult supervision, on their own, ingest, inhale, drink, or spray, the medication of chemical-based goods into their mouth or any part of their body. So while the cap 209 becomes child-proof, the skill required to open the cap and unlock the safety feature is still within capable reach of certain adults with disabilities so they may still be able to open it.

The flange also includes a section for tabs 205. These tabs 205 are removable or breakable. This tabs section 205 may include a plurality of tabs that are labeled with various hours of administration (HOA). As you know, doctors and/or authorized medical professionals typically prescribe medications for a specific patient that are to be administered at a certain time of the day, such as morning, afternoon, evening, night or a selected time frame. These times for intake of medication are referred to as hours of administration (HOA). As such, the tabs in the tabs section 205 are also labeled accordingly as morning, afternoon, evening, night or a selected time frame or any combination thereof. For example, one pill container 200 may have just 4 tabs, morning, afternoon, evening, night and another pill container may have 3 tabs, morning, afternoon, evening or any such combination. Each tab corresponds to the contents/medications stored within the pill container and provides guidance to the user/patient for whom the medications are prescribed that the patient should take the medication in that HOA.

For example, if among the plurality of tabs in the tabs section 205, only a tab labeled morning remains after processing of the pill container, then the morning tab signifies and provides guidance to the patient that the medication within is to be administered in a morning time slot.

As will be explained in further detail below, these tabs 205 are selectively removable or breakable by a tab removal machine. So, in an embodiment where the tabs included at the initial stage are morning, afternoon, evening, night and that pill container is to be filled with medication that is to be taken only in the morning time, then the other tabs (afternoon, evening, night) are removed from the tabs section 205.

The tabs have a series of perforations around them that allows them to be removed or broken away from the tab section 205 when a certain amount of pressure is applied. The pressure is significant enough that it prevents accidental breaking by a user but also within the scale and reach of the tab removal machine to be pressed and broken away.

Once the tabs that are not relevant to the particular patient, i.e. for their morning pills, are removed through processing, then the only tab that remains is the morning tab making it discernable by the patient or their caregiver that the entire bottle is for medications to be taken in the morning. Likewise, multiple tabs, such as morning and evening, or any such combination of tabs that remain on the pill container 200 signify that the pill container 200 contains medications that are to be taken both morning and evening thereby making it easy to identify and reducing patient intake error.

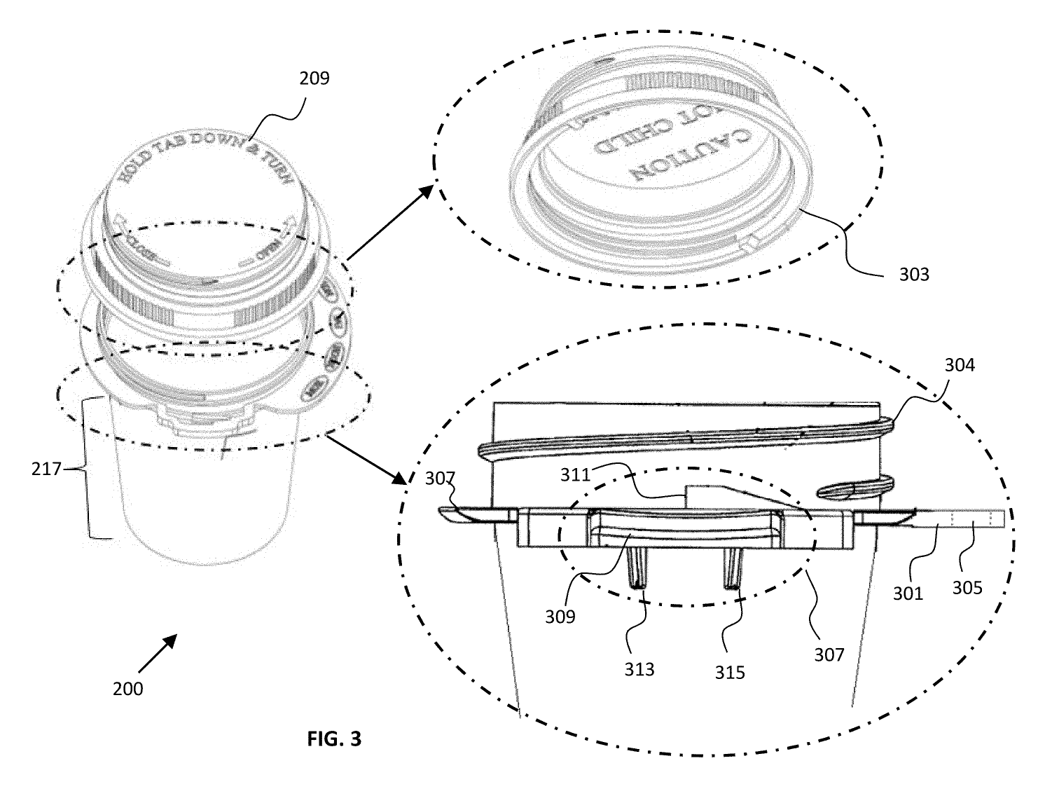

FIG. 3 is a perspective view depicting the pill container along with detailed views of its engagement sections, according to some of the disclosed embodiments.

The pill container 200 includes a flange 301. The flange 301 extends outwards from the surrounding wall 217. It surrounds a portion of the surrounding wall 217. Alternatively, the flange radially extends and surrounds the entire surrounding wall forming a circumference. Some portion of this radial and circumferential protrusion 301 also includes an engagement means. This engagement mean can engage with the cap's 209 threaded inner rim surface 303 and allow the cap to rotate about the engagement means until it can come to a stop. The completed engagement between the cap and the engagement forms a seal between the housing and the cap which then prevents any solid object or debris from entering and any solid or liquid medications from escaping the pill container. The flange 301 also acts as a position stop to limit the amount of rotation of cap 209 mounted on the pill container 200.

The flange also includes a plurality of removable or breakable tabs. Each tab is surrounded by a plurality of perforations 305. The perforations 305 for each tab are spaced apart from the perforations for the neighboring tab. The perforations 305 allow for easy breaking or removal of the tab when pushed, punched, or applied force through various means. In the current embodiment, a plunger type protrusion, a stick, or any other protrusion that can apply a pointed force, or distributed force applied over an area of the tab. The applied force would result in breaking or removing the tab along its perforated lines. The perforations protect the flange by not having any other area break or crack while a pressure is applied to the tab and result in only the breaking of the tab. The perforations also prevent a neighboring tag from any damage or removal and only break the intended tab.

The pill container 200 includes a push tab mechanism 307. This mechanism is coupled to the flange 301 and protrudes outside the exterior surface of the pill container's housing 201 towards it top end. The push tab mechanism 307 includes an engagement member 309 and a locking member 311. The push tab mechanism 307 also includes a plurality of stops, such as first stop 313 and a second stop 315. These stop members prevent further engagement or over tightening of the cap 209 with the housing once a desired tightness of the cap with the pill container 200 is achieved. The push tab assembly 307 is mounted to the exterior surface of the surrounding wall 201 through protrusions. These protrusions are resilient or elastic members and allow bending of the push tab when pushed. The protrusions return to their original shape and orientation after a push force has been released from the push tab assembly 307. The push button is relatively smooth for providing a comfortable engagement and can be operated when a user pushes it with their finger.

The locking member 311 of the push tab is shaped as an inclined surface or a cam. It includes a locking edge 311. When mounting cap 209 to the pill container 200, a locking lug of the cap 209 engages and slides along an inclined edge surface and then drops behind the locking edge 311. Engagement between the locking edge 311 and other protrusions of the locking member with the cap 209 helps to prevent the cap 209 from rotating counterclockwise for removal or loosening from the pill container 200 thereby securing a tight lock as well as accidental removal of the cap 209.

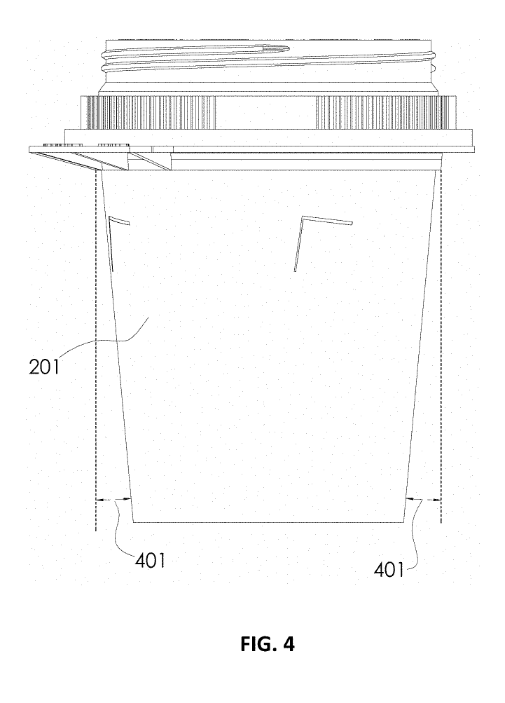

FIG. 4 is a front view of the pill container, according to some of the disclosed embodiments. As mentioned above, the housing 201 is a tapered and cylindrical in shape. The tapering angle is constant and accomplished through a wider top section and a bottom section that is narrower in diameter than the top section as such resulting in the tapered body/middle section.

The angle of tapering can vary. A higher angle 401 will allow for a deeper taper. The deeper taper will result in a narrower bottom. A lower angle will allow for a straighter housing 201, i.e. the lower or smaller the angle the wider the bottom of the pill container. An angle that allows the maximum insertion of another same sized second pill container deep into and vertical closer to the bottom edge of the first pill container is preferred. Such taper will allow maximum stacking of pill containers leaving little gape between the bottoms of each pill containers. Stackability of one pill container into another pill container, thereby allowing a plurality of pill containers to be inserted into each will allow easy storage of the pill containers as well as reduce the storage space.

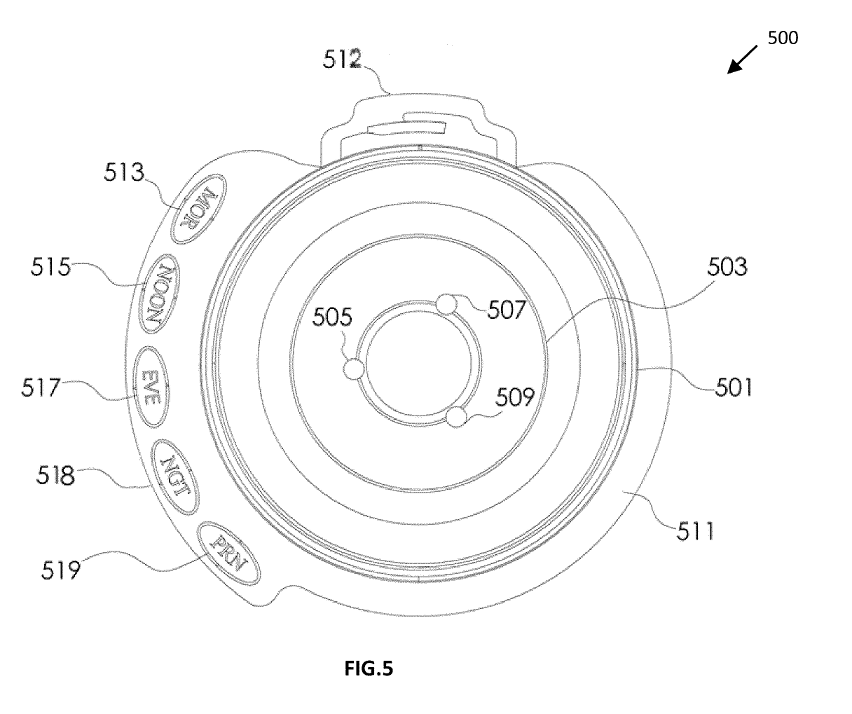

FIG. 5 is a top view of the housing of the pill container, according to some of the disclosed embodiments. The housing includes a flange 511. The flange extends radially outward from the housing 201. As mentioned above, the flange 511 includes the locking feature 203, a section for tabs 205, and an engagement surface for engaging with the cap 209.

The width of the flange 511 varies as it radially extends around the housing 201. For example, the width of the flange in the section of the flange 511 that does not include any additional features may be narrower than the width of the flange in the section where it includes the section for tabs 205 and the locking feature 203.

As part of the flange 511, the locking feature is a push and release tab 512 that protrudes outwards from the external surface of housing. The locking feature include a flexible push and release mechanism that allows it to disengage from the cap 209 when it is pressed downwards and then reengage again with the cap 209 when it is released. In its released position, a protrusion in locking mechanism extends into the cap thereby preventing the cap from being detached from the housing 201 to prevent a child from opening the vial.

The pill container has a wider top, the mouth, and a narrower bottom. The wider mouth diameter 501 includes external threads that also engage with the cap 209. Acting as a dual locking feature, both the external threads 501 as well as the locking mechanism 512 (that protrudes from the flange) add extra protection to prevent accidental opening as well as child opening. In the case of a child, since a child below a certain age lacks the coordination and/or strength that is required for a dual locking feature, the press and release locking feature 512 as well as the external threads make it difficult for a child to open the vial by removing the cap from the housing.

The narrower bottom 503 is enclosed and has a narrower diameter than the mouth at the top. At the bottom center, the vial includes a plurality of small holes or indentations or detents. The holes appear on the outside of the vial and do not extend through into the inner side of the vial, i.e. there is no opening from inside of the vial from its bottom end to the outside. As such, the plurality of indents/holes extends into the body of the pill container but not so much that they create a passage therethrough. In one embodiment, the holes only extend about half the thickness of the overall plastic thickness at the bottom section. The plurality of holes are of the same size and diameter. The number of holes vary based on the size of the pill container. For example, a larger pill container that with a wider bottom, and a bigger diameter at the bottom, may include more holes than a narrower vial. Other variations, shapes of indentation, and number of indentations are also contemplated.

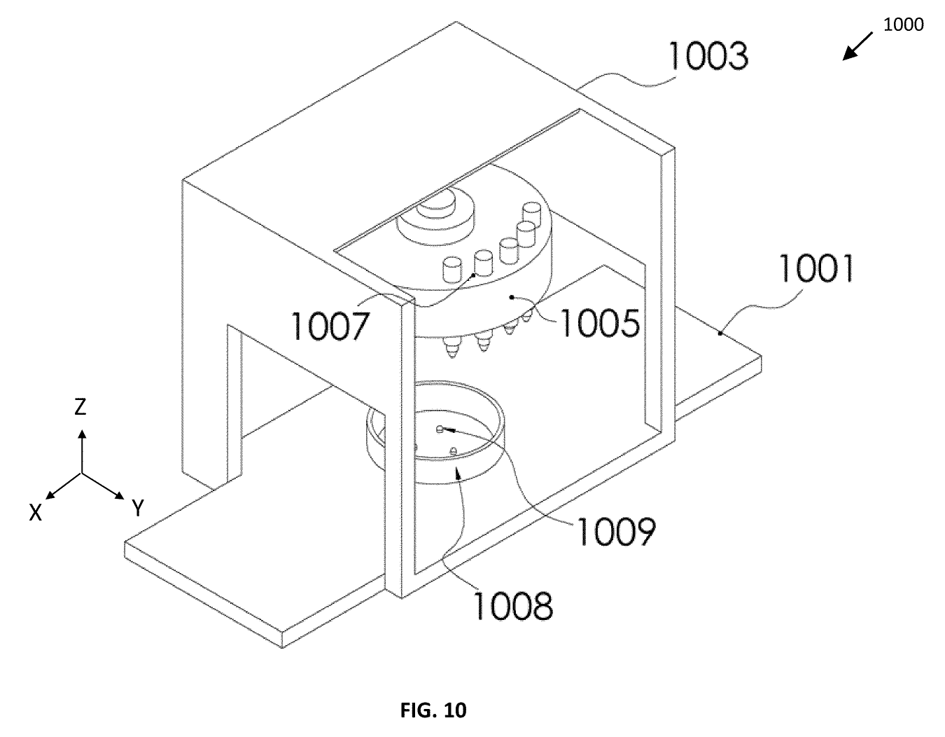

These holes/indentations or detents provide ease of manufacturing. They are also used by tab removal machine, as described in FIGS. 10, 11, and 12 to position the vial in a particular orientation and align it with respect to the tab removal machine for processing. Additional details of the use of these holes/indentation/detents is described in FIGS. 10, 11, and 12.

The flange 511 also includes a section for tabs 205. These tabs can be for times of day, days of week, or some customized tabs. For example, the flange includes tabs for Morning 513, Noon 515, Evening 517, Night 518(not on fig), and PRN 519, where PRN 19 can be a customized tab for a specific patient. PRN is also a Latin term (pro re nata) that is used in the medical space and used as an abbreviation for “when necessary”.

Each of the tabs 513-519 include a perforation around them allowing them to be easily broken off from the flange when a certain force is applied. The amount of force may vary but it would be higher than the force required to prevent accidental break off with very minimal force. For example, the pressure required may be 120 psi, which prevents accidental breaking off when touched by hand with a small force. Other measurements of force are also contemplated.

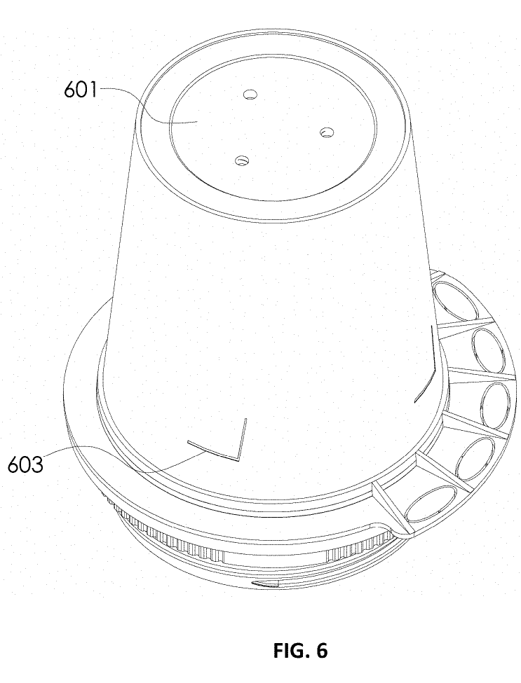

FIG. 6 is a bottom view of the housing of the pill container with detents, according to some of the disclosed embodiments. The detents, and/or holes or indentations are located at the bottom base 601 of the pill container 200. Depending on the size of the pill container, the location and number of holes may vary. For example, in a smaller size vial, there may be lesser holes due to the amount of real estate at the bottom base as oppose to a larger vial which may contain a larger number of holes. Alternatively, the same locations and number of holes may be at the base of a vial regardless of its size so that they may fit into the same location in the tab removal machine.

The pill container 200 also contains a section for a label, the labeling area 603. The label to be placed in the labeling area 603 includes information pertinent to the vial and the patient. For example, the label may include patient name, contents of the vial, such as the name of the medication, regimen details, such as number of pill enclosed in the vial as well as the days and/or times of the day when the medication is to be takes. The label may also contain any additional information necessary for the patient to administer the medication or other information that is provided by the doctor, manufacturer of medication, or required on the label due to state/federal regulation. The label information may be regular text, large text, or in braille as needed.

The location of the label is defined by the marked section 603 where the corner of a rectangular label is to start in the marked section and to wrap around the vial until it reaches the other marked section. Since the vial is a circular and tapered vial, the system calculates the size and length of the vial as well as the shape such that once wrapped, the label does not wrinkle due to the tapered shape of the housing. The system determines the right size of the sticky label required and automates the process of placing a label on the vial such that its placed accurately within the marked areas in an expeditious manner.

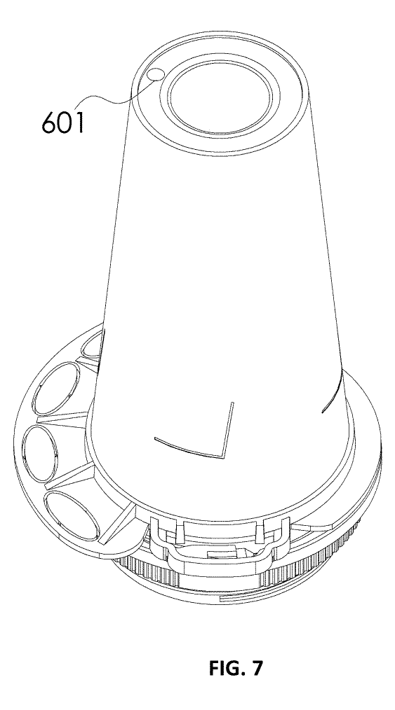

FIG. 7 is a bottom view of the housing of the pill container with a detent, according to some of the disclosed embodiments. In one embodiment, the pill container/vial of FIG. 7 is a smaller pill container 200. The smaller pill container 200 will hold a smaller number of pills. All the other features, breakable tabs, of the pill container 200 are same as the pill container of FIG. 6. In one embodiment, the smaller pill container 200 includes one detent/hole/indentation. The location of the hole from the center of the pill container may be the same distance as the locations of holes in FIGS. 6 from the center of the pill container shown in FIG. 6. Alternatively, the location of the hole may be situated such that once its placed on the tab removal machine, the hole at the base of the housing aligns with a probe or protrusion that can be inserted inside the hole for alignment and locking.

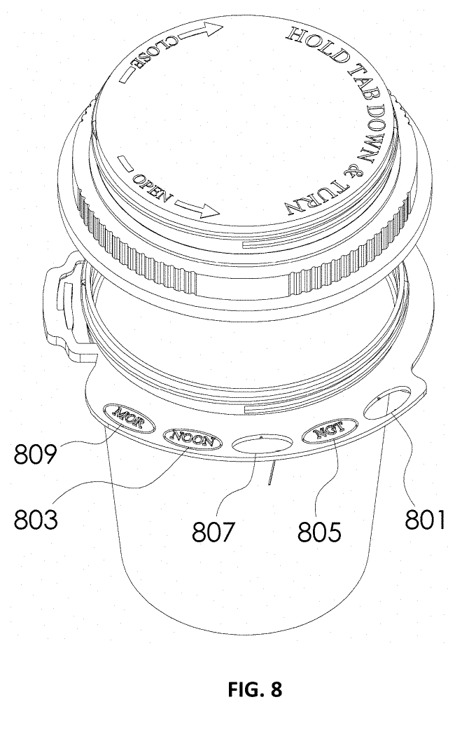

FIG. 8 is a perspective view of the pill container assembly with desired tabs removed from the flange, according to some of the disclosed embodiments. The pill container assembly includes a pill container housing and a cap. The pill container housing includes a flange having removable tabs, such as tabs for PRN 801, Night 805, Evening 807, Afternoon or Noon 803, and Morning 809. Each of the tabs includes a perforation around them allowing them to be easily broken off from the flange when a certain force is applied.

In this embodiment, the patient for which this pill container is being used is required to take certain medications that will be stored inside this pill container during Morning, Afternoon, and Night. They are not supposed to take the medication at any other time, and definitely not in evening or another customized time (PRN). Since the pill container has removable tabs for Morning, Afternoon, Evening, Night, and PRN, FIG. 8 depicts a pill container that has undergone processing through the tab removal machine, where the tabs that were not needed for this patient, i.e. Evening and PRN, were removed by applying a force and breaking them through the flange along their perforated areas. The completed pill container now includes the desired tabs, Morning, Afternoon, and Night and has a hole in other places. A patient may simply peruse their fingers over the flange of the bottle to determine the times that the medication is to be taken and then take the medications accordingly. The empty holes would alert the patient when not to take the medication without having to read labels.

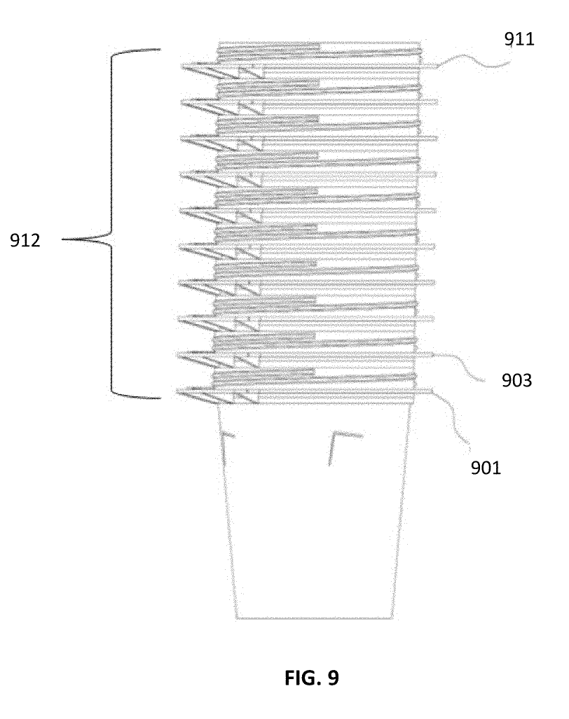

FIG. 9 is a front view of a plurality of pill containers stacked within each other, according to some of the disclosed embodiments. As mentioned in FIG. 4 above, the housing of the pill container is tapered and cylindrical in shape. The tapering allows for a wider top section and a narrower bottom and the tapered body in-between. The tapering body allows for Pill Containers 901 through 911 to be stacked within each other. A tapering angle that allows for a minimal stacking height 912 may be used. For example, a pill container with the tapering angle that allows maximum insertion of a second pill container within will be preferred to optimize the storage height 912.

FIG. 10 is a perspective view of the tab removal machine, according to some of the disclosed embodiments. The tab removal machine 1000 includes a base 1001, a cover 1003, a tab breaking mechanism 1005, a placement area 1008, and a locking/alignment protrusion 1009.

The base 1001 includes a circular protrusion 1008 that allows insertion of the base/bottom of a pill container 200. The circular protrusion 1008 is a round circular ring with a hollow inside with the base 1001 as a bottom. The circular protrusion 1008 may be coupled to the base 1001 through a variety of means, such as adhesive, fit into a circular rail or indentation, or screwed onto mating threads at the base 1008. The diameter of the circular protrusion 1008, i.e. the circular ring, provides a snug fit for the base/bottom of the pill container 200 such that once the pill container 200 is inserted inside the base 1008; it is unable to move in any direction of the XY Plane. The protrusions may be of different sizes and the round circular protrusion ring may be switched with a different size ring to accommodate for pill containers of various sizes.

Further, in one embodiment, the circular protrusion 1008 may be divided into two pieces, where the first piece of the ring is fixed and the second piece is attached to the first piece through a joint that allows the second piece to open as a door and allow for easy insertion of the pill container 200. In operation, in this embodiment, when a pill container is to be inserted inside the ring circular protrusion, the second piece may be opened as a door thereby allowing an opening to insert the pill container in the circular protrusion 1008 and then closing the second piece back to lock the pill container 200 within the ring.

Inside the circular protrusion 1008,and coupled to the base 1001 of the tab removal machine 1000, there are a plurality of small locking/alignment protrusions 1009 (or small pistons or cylindrical sticklike protrusions). These locking/alignment protrusions 1009 are to be inserted in the holes (505, 507, 509, and 601) of the pill container 200.

As mentioned earlier, depending on the type of pill container, there may be one or more holes at the base of the pill container 200. The locking/alignment protrusions 1009 of the tab removal machine 1000 fit inside the holes of the pill container 200 to align the pill container 200 with respect to the tab removal machine 1000. The alignment ensures both that the pill container 200 is placed at a desired location on the XY plane as well as it is rotated to the desired side such that the pill container's 200 tabs section 205 fits directly underneath the tab breaking mechanism 1005 with the removable tabs of the pills container aligned underneath the pistons of the tab breaking mechanism 1005. Further, the alignment also ensures that the label section of the pill container is facing outward from the tab removal machine such that the label area can be accessed from the outside and a label can be placed easily. If the orientation of the pill container is incorrect, i.e. where the label section is not facing the desired side, then the pill container is rotated until they are in the desired location. In one instance, the labeling is automated such that the system obtains the information from a database, prints the information on the label, and sticks the label on the pill container.

In the embodiments in which the pill container includes one hole at its base, the system may detect it as such and only insert the appropriate locking/alignment protrusion 1009 into the single hole such that the removable tabs of that pill container 200 also align with the tab breaking mechanism,1005 above. The locking/alignment protrusions 1008, along with the circular ring protrusion, together align the pill container 200 underneath the tab breaking mechanism 1005 as well as lock the pill container in place so that it may not move in the XY plane.

The tab breaking mechanism 1005 includes a plurality of pistons or plungers (or probes) 1007. These pistons are cylindrical and circular in shape. Alternatively, the pistons may come in several other shapes, such as oval. The cylindrical pistons have the ability to move up and down the Z axis of the tab removal machine 1000. Each piston can apply a concentrated force onto the removable tab of the pill container 200 such that once the force is applied on a selected tab from the removable tabs 114, the selected removable tab is pushed therethrough along the perforated lines.

The tab breaking mechanism 1005 may also be moved up/down along the Z-Axis. In one embodiment, tab breaking mechanism 1005 is moved vertically upwards along the Z-Axis to a height that provides a clearance for inserting a pill container 200 inside the circular protrusion 1008. Once inserted, the tab breaking mechanism 1005 is lowered back such that it sits above the pill container 200 and prevents movement of the pill container in the Z-Axis. As such, the pill container 200 is restricted in all axis before the tab breaking is begun to prevent any movement during the tab breaking that may cause errors of breaking of other undesired sections of the pill container 200.

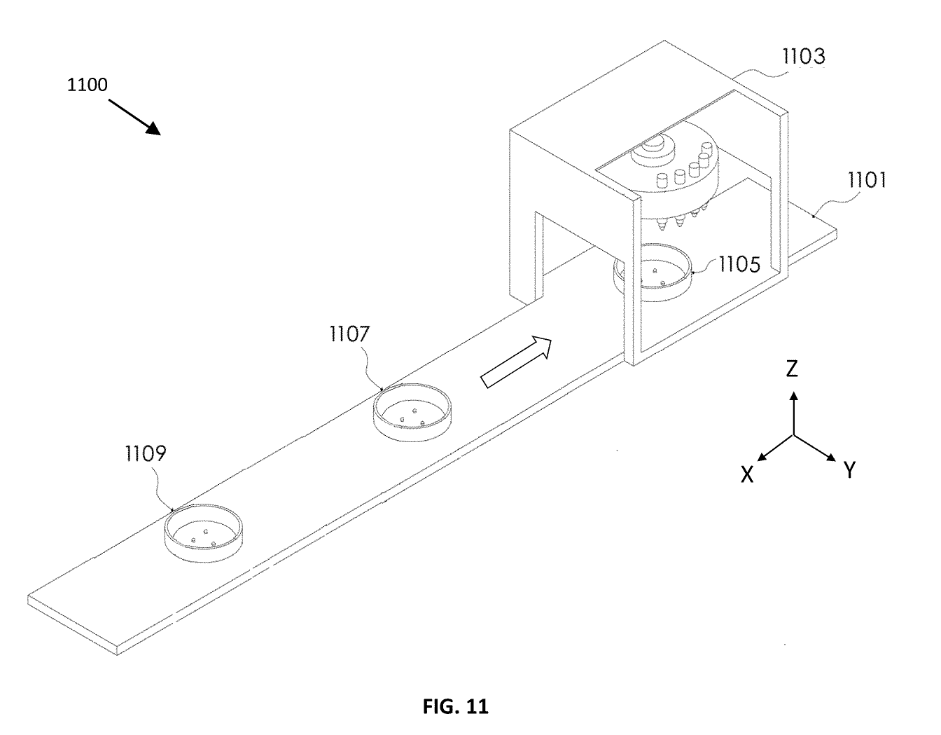

FIG. 11 is a perspective view of the tab removal machine with a conveyor belt, according to some of the disclosed embodiments. The tab removal machine 1100 includes a conveyor belt 1101, a cover 1103, a tab breaking mechanism, a plurality of circular protrusions 1105, 1107, 1109.

The conveyor belt 1101includes a plurality of circular protrusions 1105, 1107, 1109, that act as a placement area for a pill container 200. These ring-like placement areas, i.e. circular protrusions 1105, 1107, 1109 are hollow inside with the conveyor belt 1101 acting as its bottom. The diameter of the circular protrusions allows for a snug fit for the base/bottom of the pill container 200 such that once the pill container 200 is inserted inside the circular protrusion, it is unable to move in the XY direction.

The conveyor belt 1101 may include several circular protrusions. The size/diameter of all the protrusions may be the same. Alternatively, circular protrusions diameters may be different to accommodate for pill containers having different sizes, i.e., both a wider and a narrower base. In addition, the round circular protrusion rings may be switched with a different size ring to accommodate for pill containers of various sizes.

As mentioned above in FIG. 10, a plurality of locking/alignment protrusions may be located inside the circular protrusions. These locking/alignment protrusions fit inside the holes of the pill container 200 to align the pill container 200 with respect to the tab removal machine 1000.

In operation, a first pill container may be placed inside the circular protrusion 1105, a second pill container inside circular protrusion 1107, and a third pill container inside circular protrusion 1009. Since the conveyor belt can hold a plurality of circular protrusions, it is not so limited to only having three circular protrusions.

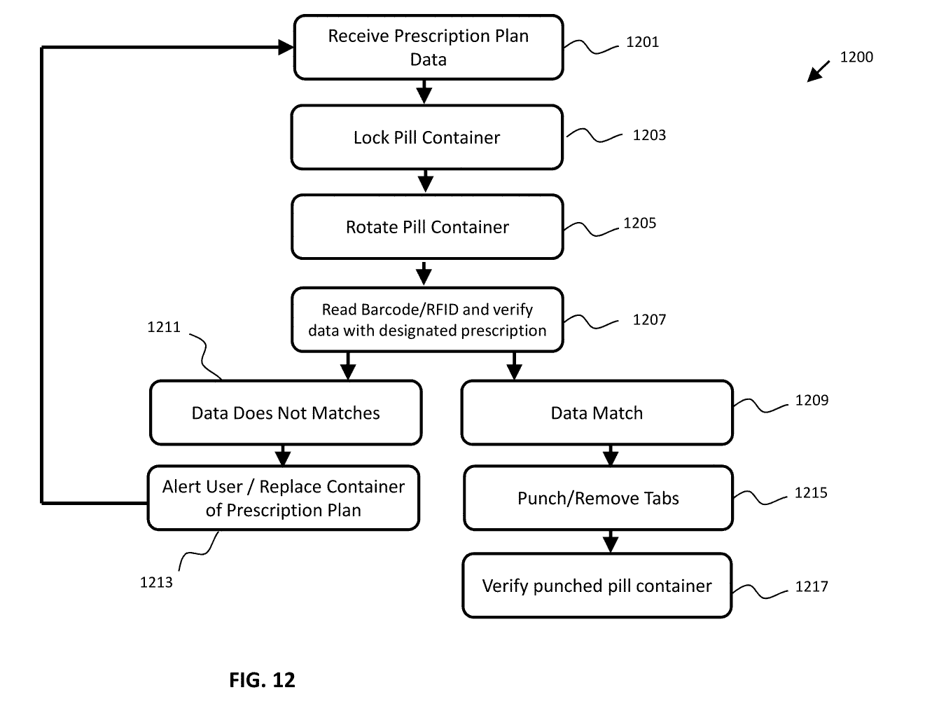

As the first pill container 200, which is placed and locked inside the first circular protrusion 1105, approaches the tab breaking mechanism 1005, the tab breaking mechanism is moved upwards to allow the lateral movement of the conveyor belt, which has the pill container inside to move directly underneath the tab breaking mechanism 1005. The system includes sensors to detect that the circular protrusion 1105 is now directly underneath the tab breaking mechanism and aligned. Upon such determination, the tab breaking mechanism 1005 is lowered until it traps the pill container in the Z-Axis. The tab removal machine 1100 gets instructions from a database, or a server or client computer, to then insert its pistons into selected tabs of the pill container 200 such that the force of the insertion breaks the desired tabs. FIG. 12 provides further details of tab removal process.

Once the processing of the first pill container 200 is verified and completed, then the tab removal machine 1100 received instructions from the database to displace the conveyor belt 1101 until the second pill container inside circular protrusion 1107 is aligned underneath the tab breaking mechanism 1005. After undergoing a similar process as the first pill container 200, the conveyor belt is displaced again until a third pill container inside circular protrusion 1009 is aligned underneath the tab breaking mechanism 1005. As such the automation process receives input from the database, which may receive the input from a user, a doctor, a pharmacy etc, that has provided instructions based on the needs of specific patients to take specific medications at a prescribed day/time and the tab breaking mechanism would remove the tabs on the pill container 200 in accordance with such prescriptions.

The tab removal machine 1100 may be configured to process all the vials/pill container for one patient at a time or it may be queued for different patient or based on the availability of medications in the pharmacy, hospital, or medication holding entity.

FIG. 12 is a flowchart illustrating one method of operation of the selectively removing a tab from the pill container, according to some of the disclosed embodiments. The tab removal method 1200, as described in this figure, is accomplished through components mentioned if FIGS. 1-11. The tab removal method 1200 utilizes a tab removal machine that engages with the pill container to selectively remove or break one or more tabs that are labeled with an HOA.

The steps of FIG. 12 can be executed using a processor of the computer. Likewise, a variety of multiprocessor systems, microprocessor-based or programmable consumer electronics can also be used. The logic to execute the steps and make decision can be saved in memory, such as RAM and stored on a CPU. Modules, such as processing module, may provide commands for steps to be executed and/or components to operate in a desired manner, such as, for example, it may direct the tab removal machine to use a certain arm to break of a certain desired tab.

At step 1201, the tab removal machine 1000 communicates with a database that stores patient information, including prescriptions, patient history, and medication information associated with that specific patient. The medication information may also include patient information, such as patient name, birth date, types of prescriptions and pills designated for the patient and other patient data relevant and needed by the pharmacies or the system to operate. The medication information also includes types and quantities of pills and their hours of administration (HOA). The tab removal machine 1000 may obtain one or more pieces of information that is relevant to a specific pill container that it will be processing.

At step 1203, the tab removal machine 1000 will determine whether a pill container is placed within is chamber. If there is a pill container already placed, then the tab removal machine 1000 will lock the pill container before proceeding with any operations. The locking may include, inserting a probe into an indent that is located at the bottom of the pill container.

At step 1205, the locking may include rotating the pill container until its top features alongside of it mouth come into contact with the internal containment features of the tab removal machine and get locked such that the pill container is prevented from any rotation during the tab removal operation.

The locking may further include lowering a cap-like round feature onto the top of the pill container such that the top opening. i.e., the mouth, of the pill container is captured within the cap-like round feature thereby preventing the pill container from moving up or down, moving sideways, of tilting at an angle, essentially locking its movement in every direction.

However, if at step 1203, the tab removal machine 1000 determines that the chamber for pill container is empty, then the tab removal machine 1000 will provide an alert signaling that an empty pill container be placed within its chamber.

A step 1207, the barcode placed on the pill container is read by the tab removal machine 1000. A bar code reader, which is coupled to tab removal machine 1000is used for reading the barcode. Alternatively, an radio frequency identification (RFID) tag is placed on the pill container, and in this case, the an RFID reader, that is coupled to tab removal machine 1000 is used for reading the RFID tag of the pill container. In either case, tab removal machine 1000 extracts the information from either the barcode or the RFID tag so it may determine patient data and the types of pills that are to be inserted in that pill container.

Once the information is obtained from the pill container, tab removal machine 1000 correlates that data with the data with database that stores patient information, including prescriptions, medication information associated with that specific patient, and their hours of administration (HOA). The goal of this verification to ensure that the right pill container that is a match for the specific patient is being processed. The verification removes any errors such as an incorrect that is not designated for that specific patient being incorrectly used for processing.

At step 1209, a data match is verified. This means that the system or tab removal machine 1000, through its verifications of pill container barcode/RFID tag and cross-checking with the database for the specific patient, verifies that the pill container it is about to process is the pill container designated for the intended patient.

At 1211, if a data match is not verified, i.e., that tab removal machine 1000 determines that an incorrect pill container, that either does not have any barcode or RFID tag or has a barcode and/or an RFID tag that is associated with a different patient, then the tab removal machine 1000 provide an alert identifying the error. The error may be displayed on a display screen with details of the error or be an audible alert.

In such a situation when a error occurs, at Step 1213, the display may alert the user with details such that the user understands that the wrong pill container was placed in the chamber while the tab removal machine 1000 was being used to process a pill container intended for another patient. Once the user replaces the chamber with the correct pill container for the intended patient, or corrects the error, then tab removal machine 1000 undergoes the steps 1201-1207 until a data match is verified.

At step 1215, tab removal machine 1000 inserts probes into various tabs of the pill container thereby applying a pressure to punch the tab through the flange until is falls out. In some embodiments, the tab to be punched situated such that it's a certain distance from the edge of the flange and therefore its removal leaves a opening, or an hole, within the flange and in other embodiments, the tab to be punched out is at the edge of the flange thereby it being punched out results in that whole section being removed and not hole or opening left behind.

Further, at Step 1215, the tab removal machine 1000 determines which tabs to remove from the tab section of the pill container. As mentioned above, pill containers include a plurality of tabs and each tab is labeled with an Hour of Administration. During its data match stage, the tab removal machine 1000 determines the HOA for the pills/medications that are to be placed inside the pill container that it is currently processing.

For example, the pill container may be associated with a prescription plan for that specific patient that requires a certain medication, such as Tylenol, to be taken twice a day, once in morning and once at nighttime. In this example, the tab removal machine 1000 determines the number and type of tabs currently on the pill container. If the pill container contains tabs for morning, afternoon, evening, and night, i.e., 4 tabs for 4 HOAs, then the tab removal machine 1000 will punch through/remove the tabs for afternoon and evening leaving behind the tabs for morning and nighttime. The end product will just have two tabs making it easy for the user to determine that HOAs for that specific container. Likewise, if the pill container contains tabs for morning, afternoon, and night, i.e. 3 tabs for 4 HOAs, then the tab removal machine 1000 will punch through/remove just one afternoon tab leaving behind the tabs for morning and nighttime. The tab removal machine 1000 has the ability to read the current tabs before processing, i.e. punching through.

Likewise, if the prescription calls for just one HOA, e.g. afternoon, then the tab removal machine 1000 will punch through all the other tabs that are for different HOAs and leave behind just the tab for afternoon. The final product makes it easy to use without having to read through labels of pill containers to determine the HOA. The final product also makes it easy for those with limited vision, blind, or people having glasses to still obtain the correct pill container at the right HOA and take the pills.

At 1217, the tab removal machine 1000 checks the final product to ensure that the intended tabs remain on the pill container. This is a double check performed by once again querying the database and matching it with final product.

In another embodiment, the tab removal machine 1000, as shown in FIG. 11, may include a conveyor belt 1101. The tab removal method 1200 would still be applicable to the tab removal machine with the conveyor belt with the following changes. The tab removal method 1200 would process one pill container at a time, as explained in process 1200, and then move onto the next pill container and repeat the process. The instructions on which tab to remove may differ for each pill container on the conveyor belt.

Further the pill removal machine may also include a plurality of sensors. The sensors may determine alignment and locking of the pill container with respect to the pill removal machine, especially it tab breaking mechanism. The sensors may also provide data on the pill containers placed on the conveyor belt such that the system is aware and processes each pill container as prescribed.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A method for removing a tab from a cylindrical pill container, wherein the pill container is used for storing and dispensing pills for a patient, the method comprising:
receiving a pill container in a chamber of a tab removal machine, wherein the chamber is located at the base of the tab removal machine, wherein the pill container comprises
a cylindrical housing extending longitudinally along an axis having a top and a bottom, wherein inside of the cylindrical housing is hollow, wherein the cylindrical housing has a top end and a bottom end, wherein the top end has an opening to the above and the bottom provides an enclosed floor to the housing,
a flange protruding outward from the top end of the housing, wherein the flange includes a plurality of removable tabs, wherein each removable tab is labeled with an hour of administration (HOA), wherein a plurality of perforations surrounds each tab;
confining the pill container at its bottom end within the chamber, wherein confining includes restricting the motion of the pill container in an XY plane;
determining the hours of administration (HOA) for the pills that are to be stored in the pill container, wherein the determination includes querying a database to obtain the HOA, wherein the HOA are associated with a specific patient for whom the pills are prescribed; and
removing those tabs that are not associated with the HOAs, wherein the removal consists of applying pressure to the tab using a movable protruding arm of the tab removal machine thereby resulting in the tab being broken away from the flange along the lines of perforations

2. The method of claim 1, wherein the cylindrical housing is tapered such that it has a wider top and a narrower bottom.

3. The method of claim 1, wherein the removable tab is labeled as Morning, Afternoon, Evening, Night, or PRN as an hour of administration, wherein PRN is a customized time for taking the medication.

4. The method of claim 1, further comprising reading a radio frequency identification (RFID) tag that is connected to the pill container, wherein the RFID tag includes information on the pills that are to the stored in the pill container and patient data associated with the stored pills.

5. The method of claim 1, wherein the tab removal machine includes a displaceable conveyor belt, wherein the conveyor belt includes a plurality of pill containers, wherein the system advances one pill container by displacing the conveyor belt and advancing the pill container such that a desired tab is removed.

6. The method of claim 1, further comprising inserting a cylindrically shaped protrusion, which is part of the tab removal machine, into an alignment hole of the pill container, wherein the cylindrically shaped protrusion is located at the base of the tab removal machine and inside the perimeter of the chamber, wherein the hole is located at the bottom of the longitudinal housing.

7. The method of claim 6, further comprising automatically rotating the pill container until the desired hole of the pill container is in alignment with the cylindrically shaped protrusion.

8. The method of claim 6, further comprising automatically placing a label on cylindrical housing of the pill container, wherein the label including patient name and name of pills stored inside the pill container.

9. A pill container assembly for storing a plurality of medical pills for a specific patient comprising:
a longitudinally tapered cylindrical housing having a top and a bottom, a wall that connects the top and the bottom forming a surrounding to a hollow enclosure for storing medical pills, wherein the top has an opening to the above, the bottom provides a floor to the housing, wherein the diameter of the top opening is wider than the diameter of the bottom, the surrounding wall having an exterior surface that is outside of the hollow enclosure and an interior surface that is the inside of the hollow enclosure, the bottom including a detent;
a flange protruding outward from the top of the housing from the exterior surface, wherein the flange includes a locking feature;
a plurality of removable tabs located within the flange,
a locking feature at the top of the housing, wherein the locking feature includes a locking means and an engaging means; and
a threaded cap, wherein the threaded cap engaged with the locking and engaging means at of the housing results in closing the top part of the housing that has an opening to the above and encapsulating the pill container such that medications inside the container are secured from the outside.

10. The pill container assembly of claim 9, wherein the longitudinally tapered cylindrical housing allows one pill container to be stored within another pill container thereby allowing a plurality of pill containers to be stacked within each other.

11. The pill container assembly of claim 9, wherein each removable tab is labeled with an hour of administration (HOA), wherein the HOA tabs identify the timing of the day at which a patient may intake the medications stored within the pill container, wherein a plurality of perforations surrounds each of the plurality of the removable tabs thereby allowing the breaking away of a removable tab along the lines of perforations upon applying a pressure.

12. The pill container assembly of claim 11, wherein the HOA tabs are a combination of morning, afternoon, evening, and night.

13. The pill container assembly of claim 11, wherein the HOA tab is a desired time, wherein the desired times identifies the time at which the pills stored inside the pills container may be taken by the patient.

14. The pill container assembly of claim 11, wherein the longitudinally tapered cylindrical housing is tapered at an angle that allows insertion of another same size pill container through its wide opening at the top thereby allowing multiple pill containers to be stacked within each other for storage.

15. The pill container assembly of claim 9, further comprising reading a radio frequency identification (RFID) tag that is connected to the pill container, wherein the RFID tag includes information about the medical pills that are to be stored within the pill container.

16. An apparatus for removing tabs of a pill container, the apparatus being communicatively networked with a database to receive a prescription for a specific patient, the prescription including hours of administration (HOA) for taking medications that are stored in the pill container having removable tabs, wherein each tab of the pill container includes one HOA, the apparatus comprising:
a base plate;
a circular protrusion connected to the base plate, wherein the circular protrusion is ring-like hollow protrusion, wherein the circular protrusion is used for housing and confining the XY movement of a pill container placed within;
an alignment protrusion located inside the circular protrusion and connected to the base plate, wherein the alignment protrusion is used for inserting into a hole that is located at the bottom of the pill container;
a cover connected to the base plate, wherein the cover provides a ceiling to the circular protrusion and the alignment protrusion;
a tab breaking mechanism connected to the ceiling of the cover, wherein the tab breaking mechanism includes a plurality of pistons that independently move up and down; and
a processing module that directs the tab breaking mechanism to remove a desired tab from the pill.

17. The apparatus of claim 16, wherein the processing module directs the tab breaking mechanism by lowering a desired piston of the tab breaking mechanism onto a desired tab of the pill container, the lowering resulting in the application of a force by the desired piston onto the desired tab, thereby resulting in the breaking away of the desired tab along its lines of perforations.

18. The apparatus of claim 16, wherein the base plate is a displaceable conveyor belt, wherein the conveyor belt includes a plurality of circular protrusions, wherein each protrusion is capable of housing a pill container.

19. The apparatus of claim 16, wherein the wherein the tab breaking mechanism is capable of vertical movement.

20. The apparatus of claim 16, further comprising a plurality of sensors, wherein the sensors determine the alignment of the pill container that is placed within the circular protrusion.
